(19) United States
(12) Patent Application Publication
(10) Pub. No.: US 2006/0256209 A1
(43) Pub. Date: Nov. 16, 2006

(54) Position detecting device and electronic apparatus

(75) Inventors: Tadahiro Yoshida, Otsu-shi (JP); Hirotoshi Konishi, Toyokawa-shi (JP); Hiroyoshi Hosota, Toyokawa-shi (JP)

Correspondence Address: SIDLEY AUSTIN LLP, 717 NORTH HARWOOD, SUITE 3400, DALLAS, TX, 75201, US

(73) Assignee: KONICA MINOLTA OPTO, INC.

(21) Appl. No.: 11/414,437

(22) Filed: Apr. 28, 2006

(30) Foreign Application Priority Data
May 10, 2005 (JP) 2005-137762

(51) Int. Cl. H04N 5/235

(52) U.S. Cl. 348/229.1

(57) ABSTRACT

A dimension between ends of a magnet is set to be larger than a moving distance of a lens of a photographing optical system. The magnet is arranged such that a direction of connecting magnetic poles (S-pole and N-pole) is substantially parallel to an optical axis direction of the lens. A Hall sensor is disposed in the center of a movable range of the lens along the optical axis direction. The magnet is mounted in a lens frame such that the center of the magnet faces the Hall sensor. Lens positions and outputs of the Hall sensor can be in one-to-one correspondence with each other within the movable range of the lens. The position detecting device and the electronic apparatus are miniaturized and produced at reduced costs.

This application is based on patent application No. 2005-137762 filed in Japan, the contents of which are hereby incorporated by references.

### BACKGROUND OF THE INVENTION

1. Field of the Invention

The present invention relates to a position detecting device for detecting a position along an optical axis direction of a lens movable along the optical axis direction, and an electronic apparatus provided with such a position detecting device.

2. Description of the Background Art

Japanese Unexamined Patent Publication No. H05-323173 discloses a technology relating to an image pickup device in which a light blocking plate integrally movable with a lens is provided, and a light emitting/receiving element (photointerrupter) is disposed at a reference position for the lens, and detection is made as to whether the lens is located at the reference position based on an output from the light emitting/receiving element.

Japanese Unexamined Patent Publication No. 2001-289605 discloses a technology relating to a position detecting device for detecting a position along a specified direction of a movable body movable along the specified direction, in which device one or more magnets and one Hall element are provided; each magnet is integrally mounted on the movable body with a direction of a line connecting the magnetic poles (S-pole and N-pole) thereof oriented parallel to a moving direction of the movable body; the Hall element is so fixed as to face the magnet at a specified distance therefrom; and the position of the movable body is detected using an output of the Hall element that changes according the position of the magnet along the specified direction.

U.S. Unexamined Patent Publication No. 2001-0035213 discloses a technology relating to a position measuring device for measuring a displacement of an intake/exhaust valve of an internal combustion engine of the electromagnetic driving type, in which device an electromagnetic actuator provided with electromagnets and a movable element made of a magnetic material is used, a permanent magnet is mounted on a drive shaft of the movable element and Hall elements are mounted on a main body of the movable element upon driving the intake/exhaust valve mounted on the drive shaft of the movable element along a direction of the drive shaft, and the position of the intake/exhaust valve is detected using a variation in the intensity of a magnetic field detected by the Hall elements according to the position of the permanent magnet mounted on the drive shaft. It is also disclosed that the Hall elements are disposed in parallel with a moving direction of the movable element and that the position of the permanent magnet is adjusted to bring the lengthwise center of the permanent magnet having magnetic poles located at ends thereof along an axial direction into alignment with the centers of the Hall elements.

According to the technology disclosed in Japanese Unexamined Patent Publication No. H05-323173, the light emitting/receiving element is relatively large-size and expensive, which consequently causes a large-size mechanism for detecting the position of the lens and an increased cost. Further at the time of production, it is necessary to adjust the positions of the light emitting/receiving element and the light blocking plate and the cost is increased by this increased number of operation steps.

Japanese Unexamined Patent Publication No. 2001-289605 discloses the detection of the position of the movable body using the output of the Hall element that changes according to the position of the magnet along the specified direction, but there is no disclosure as to the polarity of the magnetic field governing the Hall element in the cases where the movable body is located at one end and the other end of its movable range. U.S. Unexamined Patent Publication No. 2001-0035213 discloses no relationship between a distance between the ends of the respective magnetic poles, and the dimensions of the movable bodies.

### SUMMARY OF THE INVENTION

It is an object of the present invention to provide a position detection technology which is free from the problems residing in the prior art.

It is another object of the present invention to provide a position detecting device, a photographing optical system, and an electronic apparatus that can be miniaturized and produced at reduced costs.

According to an aspect of the invention, a position of a movable lens provided in a photographing optical system along an optical axis direction of the photographing optical system is obtained by a combination of: a magnet integrally movable with the lens with a direction of a line connecting the N-pole and the S-pole thereof oriented substantially parallel to the optical axis direction, a dimension between the respective ends of the magnetic poles being larger than a moving distance of the lens along the optical axis direction; a Hall element disposed within a movable range of the lens along the optical axis direction; a detector for detecting a correspondence between outputs of the Hall element and positions of the lens along the optical axis direction; and a position deriving section for deriving a position of the lens along the optical axis direction based on an output from the Hall element and a detection result by the detector after a detection processing by the detector.

These and other objects, features, aspects and advantages of the present invention will become more apparent upon a reading of the following detailed description and accompanying drawings.

### BRIEF DESCRIPTION OF THE DRAWINGS

FIG. 1A is a front view showing a front external configuration of a mobile phone provided with a photographing function as one example of an electronic apparatus according to an embodiment of the invention.

FIG. 1B is a rear view showing a rear external configuration of the mobile phone.

FIG. 2 is a diagram showing a construction of a lens position detector for detecting a position of a movable lens unit of a photographing optical system along an optical axis direction.

FIGS. 3A to 3C are diagrams showing a positional relationship between a magnet and a Hall sensor when the lens is located in the center of a movable range along the optical axis direction, the one when the lens is located at one end of the movable range, and the one when the lens is located at the other end of the movable range, respectively.

FIG. 4 is a graph in which the horizontal axis represents a position of the magnet (corresponding to a position of the lens) along the optical axis direction and the vertical axis represents a magnetic flux density B at a disposed position of the Hall sensor when the magnet is located at the respective positions along the optical axis direction.

FIGS. 5A and 5B are diagrams showing assumable positional relationships between the magnet and the Hall sensor when the magnet is arranged such that a direction of a line connecting the magnetic poles thereof is normal to an optical axis.

FIG. 6 is a diagram showing a characteristic of a Hall element.

FIG. 7 is a circuit diagram of a detecting circuit to be installed in the Hall sensor.

FIG. 8 is a block diagram showing a system of the mobile phone.

FIG. 9 is an exemplary table for lens position detection generated by a table generator.

FIG. 10 is a flowchart showing a procedure of generating a table for lens position detection.

FIG. 11 is a flowchart showing a procedure of detecting a position of the movable lens unit of the photographing optical system.

FIG. 12 is a circuit diagram showing a modified detecting circuit to be installed in the Hall sensor.

### DETAILED DESCRIPTION OF THE PREFERRED EMBODIMENTS OF THE INVENTION

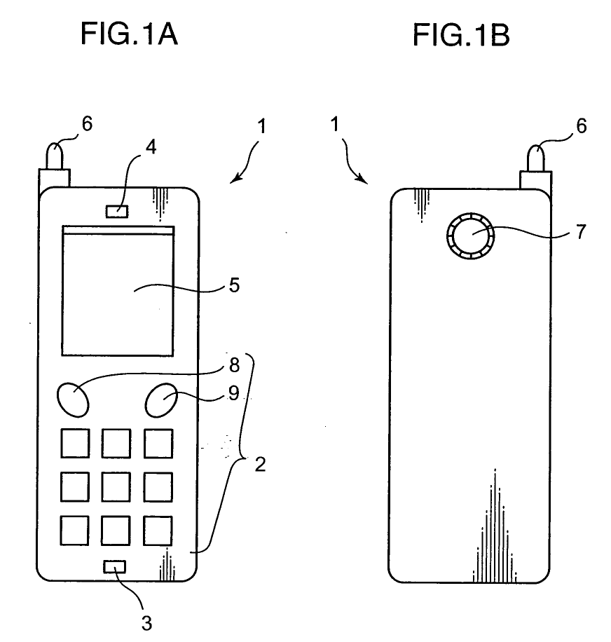

An electronic apparatus according to an embodiment of the present invention is described. FIGS. 1A and 1B are views showing an external configuration of a mobile phone provided with a photographing function as an exemplary electronic apparatus, wherein FIG. 1A shows an operation surface of the mobile phone and FIG. 1B shows a rear surface opposite to the operating surface.

As shown in FIGS. 1A and 1B, a mobile phone 1 is provided with an entering unit 2, a sound input unit 3, a sound output unit 4, an image display unit 5, an antenna 6 and a photographing optical system 7.

The entering unit 2 includes a plurality of push buttons arranged in a matrix, to which numbers, functions, etc. are assigned, and is used to enter telephone numbers and various commands. The mobile phone 1 has a photographing function, and the entering unit 2 includes a shutter button 8 used by an operator to give a photographing instruction to the mobile phone 1 and a power button 9 used to turn the mobile phone 1 on and off.

The sound input unit 3 is adapted for inputting voices of a user of the mobile phone 1 and other sounds and is constructed, for example, by a microphone for converting a sound into an electrical signal. The sound output unit 4 is adapted for outputting voices and other sounds received from other communication apparatus to the outside and is constructed, for example, by a speaker for converting an electrical signal into a sound.

The image display unit 5 is, for example, an LCD (liquid crystal display) and is adapted to display the entered telephone numbers and various setting screens. The image display unit 5 is not limited to the LCD, and may be an organic EL or a plasma display device. The antenna 6 is adapted for transmitting and receiving radio waves to conduct communications with other communication apparatus.

The photographing optical system 7 includes a zoom lens unit for changing a magnification and a focusing lens unit for focus adjustment, which are constructed to be movable along a direction normal to the front and rear surfaces of the mobile phone 1, and an objective lens exposed at the rear surface of the mobile phone 1. This embodiment is characterized by a construction for detecting a position of a movable lens unit provided in the photographing optical system 7 along an optical axis direction of the photographing optical system 7.

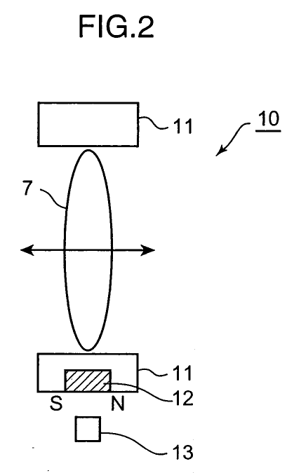

FIG. 2 is a diagram showing a construction of a lens position detector 10 for detecting a position of a movable lens unit of the photographing optical system 7 along the optical axis direction. In FIG. 2, it should be noted that a single lens is shown as a movable lens unit.

As shown in FIG. 2, the lens position detector 10 includes an elongated (bar-shaped) magnet 12 mounted in a lens frame 11 provided in the lens unit, and a Hall sensor 13 disposed at a specified position along the optical axis direction. The magnet 12 is so mounted as to be integrally movable with the lens unit such that a direction of a line connecting the magnetic poles (S-pole and N-pole) thereof is substantially parallel to the optical axis direction (directions of arrows) of the lens unit. It should be noted that the shape of the magnet 12 is not limited to the elongated one.

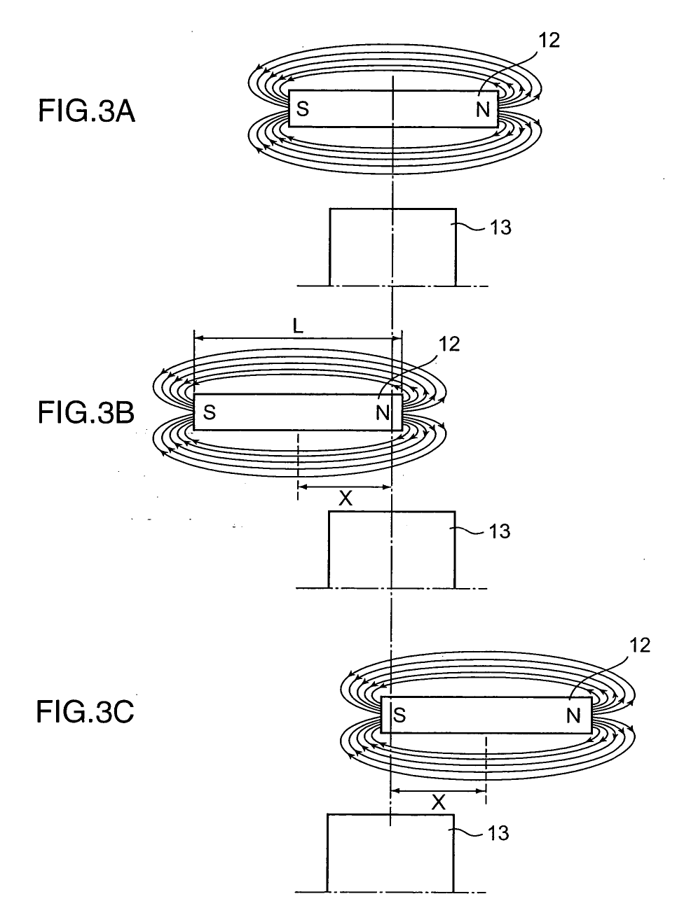

FIG. 3A shows a positional relationship between the magnet 12 and the Hall sensor 13 when the lens unit is located in the center of a movable range along the optical axis direction; FIG. 3B shows the one when the lens unit is located at one end of the movable range; and FIG. 3C shows the one when the lens unit is located at the other end of the movable range.

As shown in FIGS. 3A to 3C, a dimension L between the ends of the magnetic poles of the magnet 12 is set to be longer than a moving distance 2× of the lens unit. Further, as shown in FIG. 3A, the Hall sensor 13 is arranged in the center of the movable range of the lens unit along the optical axis direction, and the magnet 12 is so mounted in the lens frame 11 that the center of the magnet 12 faces the Hall sensor 13 when the magnet 12 is located in the center of the movable range of the lens unit along the optical axis direction.

Thus, the position of the lens unit where the center of the magnet 12 faces the Hall sensor 13 is set to be a home position. FIG. 3B shows a state where the Hall sensor 13 is governed by the N-pole, whereas FIG. 3C shows a state where the Hall sensor 13 is governed by the S-pole. Hereinafter, the position of the lens unit along the optical axis direction is referred to as a lens position.

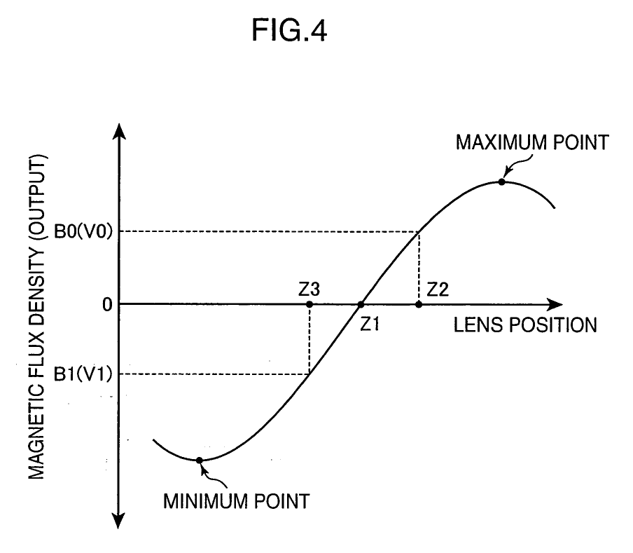

FIG. 4 is a graph in which the horizontal axis represents a position of the magnet 12 (corresponding to a lens position) along the optical axis direction and the vertical axis represents a magnetic flux density (corresponding to an output of the Hall sensor 13) B at the disposed position of the Hall sensor 13 when the magnet 12 is located at the respective positions along the optical axis direction.

In the case where the magnet 12 designed as described above is moved along the optical axis direction, the magnetic flux density changes to have a minimum value and a maximum value at certain positions of the magnet 12 along the optical axis direction as shown in FIG. 4 if a magnetic field at one side of the optical axis direction is assumed to have a positive polarity.

In this embodiment, the lens position is detected using the magnetic flux density in a range between the maximum value and the minimum value. Specifically, if B0 and B1 denote a magnetic flux density B at an optical infinity position Z2 and a magnetic flux density B at a macro position Z3 as shown in FIG. 4, the dimension L of the magnet 12 and the disposed position of the Hall sensor 13 are set such that the magnetic flux densities B0 and B1 take values between the minimum value and the maximum value (values between the minimum point and the maximum point shown in FIG. 4).

Further, in this embodiment, the Hall sensor 13 is disposed at a center Z1 of the movable range of the lens unit along the optical axis direction such that the intensities of the magnetic flux densities at the optical infinity position Z2 and the macro position Z3 of the lens unit are substantially equal (maximum) although having opposite polarities, and the magnet 12 is mounted in the lens frame 11 such that the center of the magnet 12 faces the Hall sensor 13 when the lens unit is located in the center of the movable range along the optical axis direction.

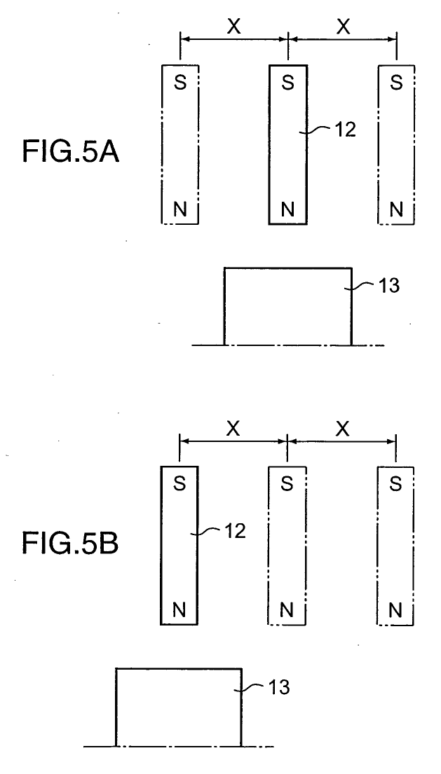

In this way, the lens positions and the outputs of the Hall sensor 13 can be in one-to-one correspondence with each other within the movable range of the lens unit. Specifically, if the magnet 12 is disposed such that a direction of a line connecting the magnetic poles (S-pole and N-pole) thereof is normal to an optical axis and the Hall sensor 13 is disposed in the center of the movable range of the lens unit as shown in FIG. 5A, the output value of the Hall sensor 13 is same (same absolute value and same polarity of the output value) in the case where the magnet 12 (lens unit) is moved only a distance x from the center of the movable range along the optical axis direction toward the optical infinity position and in the case where it is moved only the distance x toward the macro position. Thus, in a mode shown in FIG. 5A, a plurality of lens positions can be thought in relation to the same output value of the Hall sensor 13. Therefore, a single lens position cannot be detected from the output of the Hall sensor 13.

Contrary to this, since the output value of the Hall sensor 13 changes according to the lens position of the photographing optical system 7 in this embodiment, the lens position of the photographing optical system 7 can be derived one-to-one from the output of the Hall sensor 13.

If the magnet 12 is disposed such that the direction of the line connecting the magnetic poles thereof is normal to the optical axis and the Hall sensor 13 is disposed at one end of the movable range of the lens unit as shown in FIG. 5B, the lens positions and the outputs of the Hall sensor 13 can be in one-to-one correspondence with each other. By constructing such that the output value of the Hall sensor 13 is “0” at a center position of the movable range of the lens unit as in this embodiment, the magnitudes of the output values obtained from the Hall sensor 13 are half the magnitudes of the output values obtained in the construction shown in FIG. 5B. Therefore, if errors in the positions of the magnet 12 and the Hall sensor 13 along the optical axis direction are supposed, a maximum value of output errors of the Hall sensor 13 caused by such errors can also be halved.

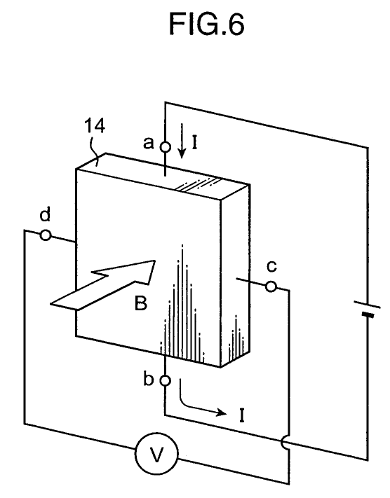

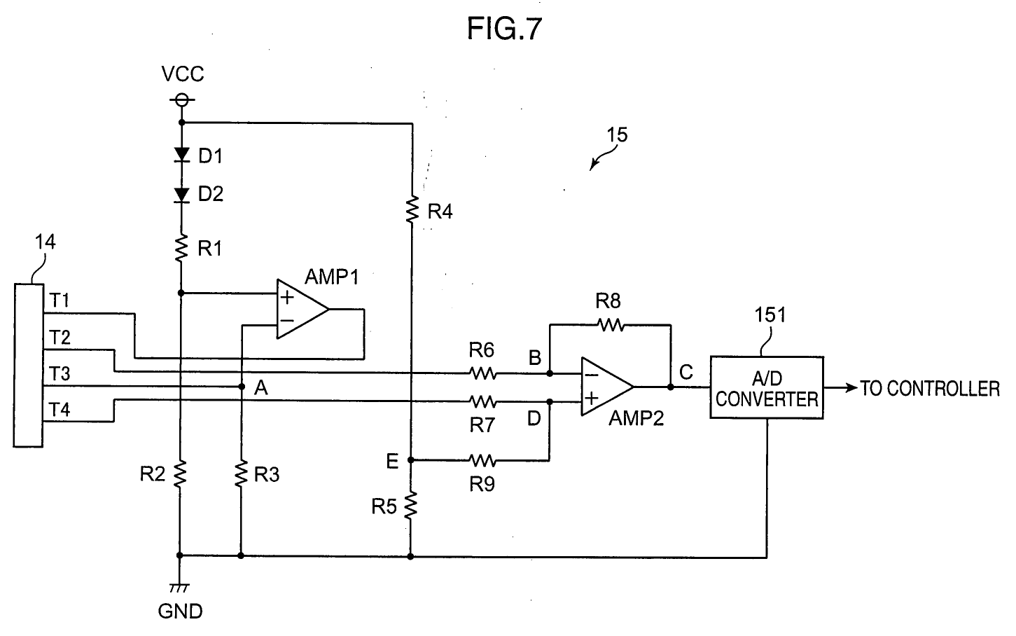

As shown in FIG. 7, the Hall sensor 13 is provided with a Hall element 14 and a detecting circuit 15. As shown in FIG. 6, the Hall sensor 14 is such an element that, if a current I is caused to flow to the Hall element 14 via terminals a, b when an external magnetic field B is present, a current corresponding to the magnitude of the current I flows (a voltage is produced) in a direction (between terminals c, d) perpendicular to a direction of the external magnetic field B and a flowing direction of the current I.

The detecting circuit 15 includes diodes D1, D2, resistance elements R1 to R9, operational amplifiers AMP1, AMP2, and an A/D (analog-to-digital) converter 151 as shown in FIG. 7. An anode of the diode D1 is connected with a power supply Vcc and a cathode thereof is connected with an anode of the diode D2, whereas a cathode of the diode D2 is connected with one terminal of the resistance element R1.

The operational amplifier AMP1 has a non-inverting input terminal connected with the other terminal of the resistance element R1, an inverting input terminal connected with one terminal of the resistance element R3 and an output terminal connected with an input terminal T1 of the Hall element 14. An input terminal T3 of the Hall element 14 is connected with a node A between the inverting input terminal of the operational amplifier AMP1 and the resistance element R3. One terminal of the resistance element R2 is connected with the other terminal of the resistance element R1, and the other terminals of the resistance elements R2, R3 are connected with ground (GND). The input terminals T1, T3 of the Hall element 14 correspond to the terminals a, b shown in FIG. 6.

A constant current circuit for supplying a constant current to the Hall element 14 is formed by the diodes D1, D2, the operational amplifier AMP1 and the resistance elements R1 to R3. Here, the diodes D1, D2 are installed as diodes for temperature compensation, and the temperature characteristics of the magnet 12 and the Hall element 14 are canceled out using the temperature characteristic of the diodes D1, D2.

More specifically, the magnet 12 has such a temperature characteristic that a magnetic force decreases as the temperature thereof increases, and the Hall element 14 has such a temperature characteristic that an output voltage decreases as the temperature thereof increases. On the other hand, the diodes D1, D2 have such a characteristic that a forward-direction voltage decreases at a substantially constant rate (e.g. −0.002 V/C ) as the temperature thereof increases. Here, assuming a case where the temperature increases, the output voltage of the Hall element 14 decreases as the temperature increases. Since the forward-direction voltages of the diodes D1, D2 also decrease, a reference voltage of the constant current circuit (input voltage to the non-inverting input terminal of the operational amplifier AMP1) increases, wherefore an input current (input voltage) to the Hall element 14 increases. Accordingly, a decrease in the output voltage of the Hall element 14 resulting from a temperature increase is canceled out by an increase in the output voltage of the Hall sensor 14 caused by an increase in the input voltage. Therefore, even if the temperatures of the magnet 12 and the Hall element 14 change, a specified output value corresponding to the lens position can be stably obtained from the Hall element 14.

A series circuit of resistance elements R4, R5 is formed between the power supply Vcc and the ground (GND). The operational amplifier AMP2 has an inverting input terminal thereof connected with an output terminal T2 of the Hall element 14 via a resistance element R6, a non-inverting input terminal thereof connected with an output terminal T4 of the Hall element 14 via a resistance element R7 and an output terminal thereof connected with the A/D converter 151. The output terminals T2, T4 of the Hall element 14 correspond to the terminals c, d shown in FIG. 6.

A resistance element R8 is connected between a node B between the inverting input terminal of the operational amplifier AMP 2 and the resistance element R6 and a node C between the output terminal of the operational amplifier AMP2 and the A/D converter 151, and a resistance element R9 is connected between a node D between the non-inverting input terminal of the operational amplifier AMP2 and the resistance element R7 and a node E between the resistance elements R4 and R5.

A differential amplifying circuit for amplifying a difference (Hall voltage generated by the Hall element 14) between the output values from the output terminals T2 and T4 of the Hall element 14 is formed by the resistance elements R4 to R9 and the operational amplifier AMP2.

The A/D converter 151 is adapted for converting the output (analog value) from the operational amplifier AMP2 into a digital value of a specified bit number, and an output thereof is fed to a controller 23 to be described later.

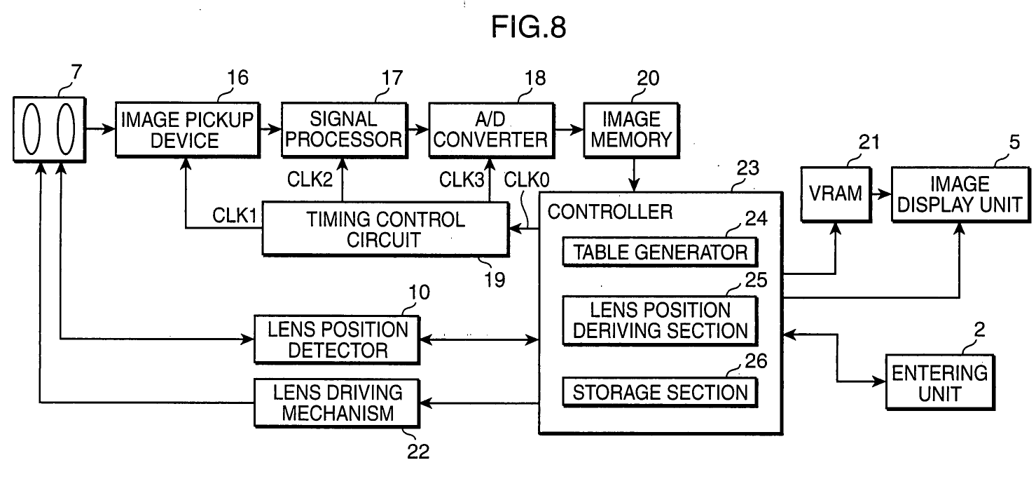

FIG. 8 is a block diagram showing a system of the mobile phone 1. It should be noted that a construction for realizing the photographing function is shown in FIG. 8, but a construction for realizing a communication function is not shown. In FIG. 8, the same elements as those shown in FIGS. 1 and 2 are identified by the same reference numerals.

The mobile phone 1 is provided with an entering unit 2, an image display unit 5, a photographing optical system 7, a lens position detector 10, an image pickup device 16, a signal processor 17, an A/D converter 18, a timing control circuit 19, an image memory 20, a VRAM (video random access memory) 21, a lens driving mechanism 22 and the controller 23.

The entering unit 2 and the photographing optical system 7 correspond to those shown in FIG. 1, and the image display unit 5 corresponds to the one shown in FIG. 2. The lens position detector 10 corresponds to the one shown in FIG. 2.

The image pickup device 16 is a CCD color area sensor of the Bayer array in which a plurality of photoelectric conversion elements such as photodiodes are two-dimensionally arrayed in a matrix, and color filters of R (red), G (green) and B (blue) having different spectral characteristics are arranged on light receiving surfaces of the respective photoelectric conversion elements at a ratio of 1:2:1. In the following description, a unit of one photoelectric conversion element having a color filter mounted thereon is referred to as a pixel of the image pickup device 16. The image pickup device 16 converts a light image of an object focused by the photographing optical system 7 into analog electrical signals (image signals) of the respective color components R, G, B and outputs them as image signals of the respective colors R, G, B.

The signal processor 17 is adapted for applying a specified analog signal processing to analog pixel signals outputted from the image pickup device 16. The signal processor 17 includes a CDS (correlated double sampling) circuit and an AGC (automatic gain control) circuit, wherein the CDS circuit is adapted for reducing noises of the pixel signals and the AGC circuit is adapted for the level adjustment of the pixel signals.

The A/D converter 18 is adapted for converting the analog pixel signals of R, G, B outputted from the signal processor 17 into digital pixel signals each consisting of a plurality of bits. The timing control circuit 19 generates clocks CLK1, CLK2, CLK3 based on a reference clock CLK0 outputted from the controller 23 and outputs the clock CLK1 to the image pickup device 16, the clock CLK2 to the signal processor 17 and the clock CLK3 to the A/D converter 18, thereby controlling the operations of the image pickup device 16, the signal processor 17 and the A/D converter 18.

The image memory 20 is a memory used to temporarily save the pixel signals outputted from the A/D converter 18 and used as a work area for applying various processings to the image signals by means of the controller 23. The VRAM 21 is a buffer memory for the image signals of an image to be reproduced and displayed on the image display unit 5 and has a storage capacity for storing the pixel signals corresponding to the number of pixels of the image display unit 5.

The lens driving mechanism 22 includes, for example, an unillustrated helicoid, an unillustrated gear for rotating the helicoid, and an unillustrated actuator and is adapted for moving a lens unit of the photographing optical system 7 along a direction parallel to the optical axis.

The controller 23 is a microcomputer having a built-in storage section 26 including, for example, a ROM storing a control program and a RAM for temporarily saving data, and controllably drives the aforementioned respective members in relation to each other. The controller 23 also functionally includes a table generator 24, a lens position deriving section 25 and the storage section 26 in order to detect the lens position of the photographing optical system 7 along the optical axis.

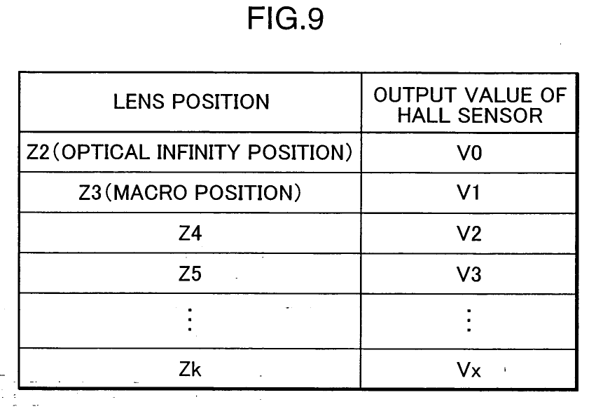

The table generator 24 is adapted for obtaining output values of the Hall sensor 13 at a plurality of lens positions including the optical infinity position Z2 and the macro position Z3 and generating a table showing a correspondence between the respective lens positions and the output values of the Hall sensor 13 (hereinafter, “table for lens position detection”). FIG. 9 shows one example of the table for lens position detection generated by the table generator 24.

The table shown in FIG. 9 indicates, for example, that an output value “V0 (see FIG. 4)” was obtained from the Hall sensor 13 at the optical infinity position Z2, an output value “V1 (see also FIG. 4)” was obtained from the Hall sensor 13 at the macro position, and an output value “V2” was obtained from the Hall sensor 13 at a lens position Z4 between the optical infinity position Z2 and the macro position Z3. The generation of the table for lens position detection is carried out, for example, when the mobile phone 1 is turned on.

The lens position deriving section 25 is adapted for detecting the current lens position of the photographing optical system 7 from the current output vale of the Hall sensor 13 by referring to the table for lens position detection generated by the table generator 24. For example, if the output value representing a voltage V1 is obtained from the Hall sensor 13, the lens position deriving section 25 derives that the lens unit is currently located at the macro position Z3 by referring to the table for lens position detection.

The storage section 26 is adapted for saving the table for lens position detection generated by the table generator 24.

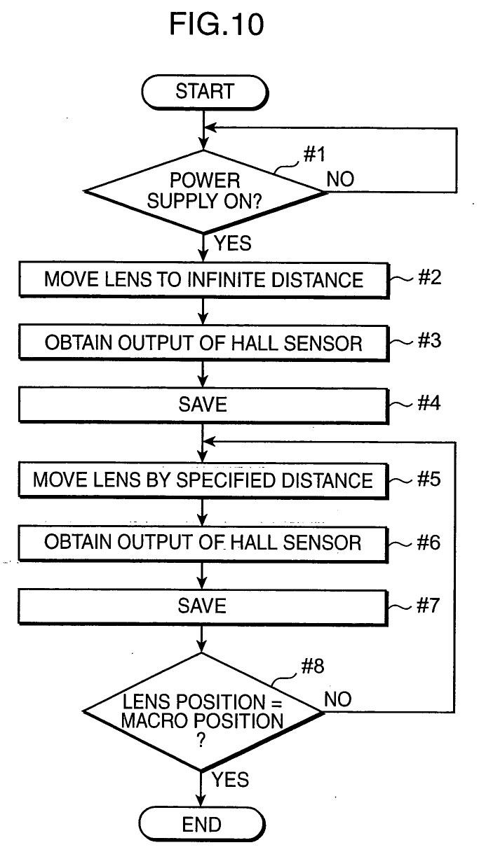

FIG. 10 is a flowchart showing a procedure of generating the table for lens position detection.

As shown in FIG. 10, when a main power supply of the mobile phone 1 is turned on (YES in Step #1), the controller 23 causes the lens unit to be located at the optical infinity position (infinite distance) Z2 (Step #2) and the output value of the Hall sensor 13 is obtained (Step #3). The controller 23 saves this lens position and the obtained output value of the Hall sensor 13 in the storage section 26 while relating them to each other (Step #4).

Subsequently, the controller 23 allows the movement of the lens unit by a specified distance from the optical infinity position Z2 toward the macro side (Step #5), obtains the output values of the Hall sensor 13 similar to Steps #2, #3 (Step #6), and saves this lens position and the obtained output (voltage value) of the Hall sensor 13 in the storage section 26 while relating them to each other (Step #7).

Then, the controller 23 judges whether or not the lens position of the photographing optical system 7 is currently at the macro position (Step #8), and carries out the operations of Steps #5 to #8 if the current lens position is not at the macro position Z3 (NO in Step #8) while ending the procedure of generating the table for lens position detection if the current lens position is at the macro position Z3 (YES in Step #8).

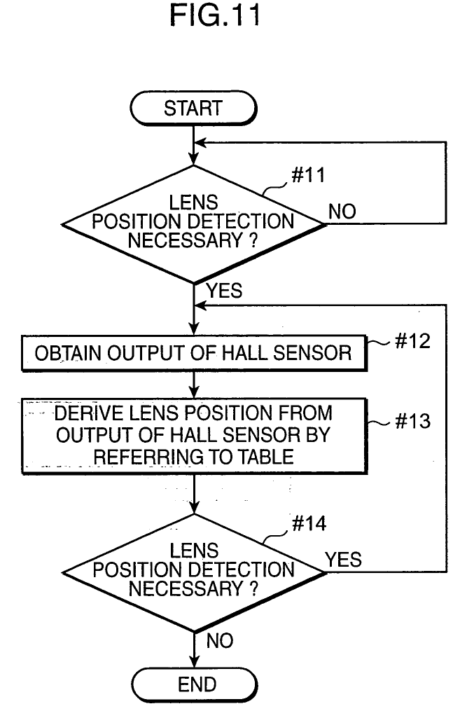

FIG. 11 is a flowchart showing a procedure of detecting the lens position of the photographing optical system 7.

As shown in FIG. 11, if the lens position of the photographing optical system 7 needs to be detected (YES in Step #11), the output of the Hall sensor 13 is obtained (Step #12) and the lens position corresponding to the obtained output value of the Hall sensor 13 is derived with reference to the table for lens position detection generated in the procedure shown in FIG. 10 (Step #13). Thereafter, it is judged again whether or not the lens position of the photographing optical system 7 needs to be detected (Step #14). The operations of Steps #12 to #14 are carried out if the detection is necessary (YES in Step #14), whereas this procedure is ended if the detection is no longer necessary (NO in Step #14).

As described above, the magnet 12 capable of integrally moving with the lens unit along the optical axis direction and the Hall sensor 13 disposed at the specified position along the optical axis direction are provided, and the lens position of the photographing optical system 7 is detected by detecting a change in the magnetic field of the magnet 12 by means of the Hall sensor 13. Thus, the lens position detecting mechanism can be smaller and produced at a lower cost as compared to the conventional one using a light emitting/receiving element and a light blocking plate. Further, the table for lens position detection showing the correspondence between the output values of the Hall sensor 13 and the lens positions of the photographing optical system 7 is generated beforehand, and the lens position of the photographing optical system 7 along the optical axis direction is derived in accordance with this table. Therefore, it is not necessary to adjust the positions of the light emitting/receiving element and the light blocking plate at the time of producing the mobile phone 1 as before, and a cost reduction can be realized by eliminating operation steps for such adjustments.

In this embodiment, the dimension L between the ends of the magnet 12 is set to be larger than the moving distance 2× of the lens unit; the magnet 12 is arranged such that the direction of the line connecting the magnetic poles thereof (S-pole and N-pole) is substantially parallel to the optical axis direction of the photographing optical system 7; the Hall sensor 13 is disposed in the center of the movable range of the lens unit along the optical axis direction; and the magnet 12 is mounted in the lens frame 11 such that the center of the magnet 12 faces the Hall sensor 13. Thus, the lens positions and the outputs of the Hall sensor 13 can be in one-to-one correspondence with each other within the movable range of the lens unit. As a result, the lens position can be securely detected as compared to the aforementioned construction (construction shown in FIG. 5A) in which a plurality of lens positions can be thought for one output of the Hall sensor 13.

Further, since the diodes D1, D2 for temperature compensation are provided in the detecting circuit 15 within the Hall sensor 13, the temperature characteristics of the magnet 12 and the Hall element 14 can be canceled out. As a result, even if the temperatures of the magnet 12 and the Hall element 14 change, substantially the same output value can be obtained for the same lens position from the detecting circuit 15, wherefore a highly reliable lens position detecting operation can be carried out.

In addition to the contents of the first embodiment or in place of the first and second embodiments, the present invention may be modified as in the following embodiments (1) to (3).

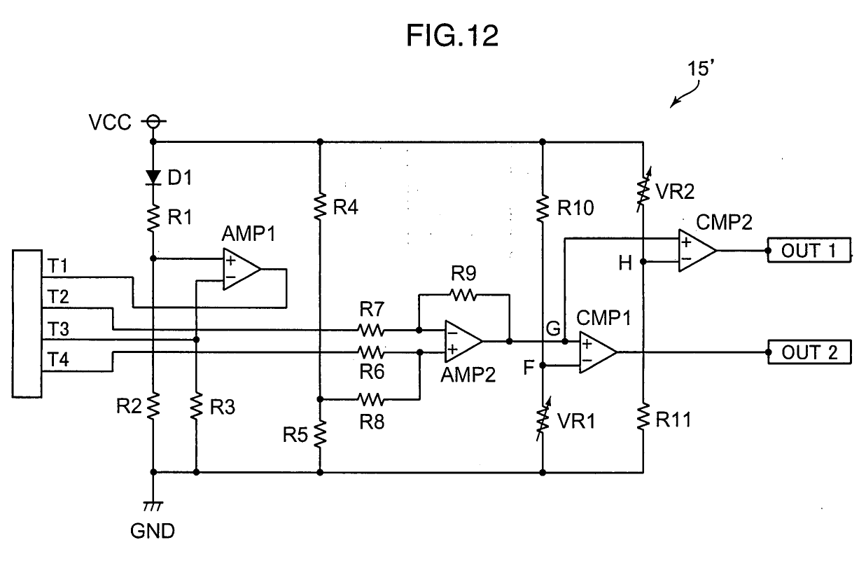

(1) The detecting circuit installed in the Hall sensor 13 is not limited to the one shown in FIG. 7, and may have such a circuit construction as shown in FIG. 12, for example, if it is sufficient for the detecting circuit to make a detection only when the lens unit is located at the optical infinity position and the macro position.

As shown in FIG. 12, a detecting circuit 15′ of this embodiment differs in that resistance elements R10, R11, variable resistors VR1, VR2, comparators CMP1, CMP2 are provided in place of the A/D converter 151 of the detecting circuit in the first embodiment and that only the diode D1 is installed because the magnitude of the power supply voltage Vcc differs from (is smaller than) that of the first embodiment, but is substantially similar to the first embodiment as for the other elements and the connections thereof. Accordingly, only points of differences from the first embodiment are described.

In this detecting circuit 15′, a parallel circuit of a series circuit of the resistance element R10 and the variable resistor VR1 and a series circuit of the resistance element R11 and the variable resistor VR2 is connected between the power supply Vcc and the ground (GND). Further, the comparator CMP1 has a non-inverting input terminal thereof connected with the output terminal of the operational amplifier AMP2 while having an inverting input terminal thereof connected with a node F between the resistance element R10 and the variable resistor VR1. The comparator CMP2 has a non-inverting input terminal connected with a node G between the non-inverting input terminal of the comparator CMP1 and the output terminal of the operational amplifier AMP2 while having an inverting input terminal thereof connected with a node H between the resistance element R11 and the variable resistor VR2. Output terminals of the comparators CMP1, CMP2 are connected with the controller 23 (see FIG. 8).

Resistance values of the variable resistors VR1, VR2 are adjusted such that one of the comparators CMP1, CMP2 inverts at the optical infinity position and the other thereof inverts at the macro position. Specifically, an H (high)-signal is outputted from the one comparator when the lens position of the lens unit is located at the optical infinity position, whereas an H(high)-signal is outputted from the other comparator when the lens position is located at the macro position. In other words, a combination of the outputs of the comparators CMP1, CMP2 is either (H, L) or (L, H).

Accordingly, upon detecting the lens position, whether the lens position of the photographing optical system 7 is located at the optical infinity position or at the macro position can be detected based on whether the combination of the outputs of the comparators CMP1, CMP2 is (H, L) or (L, H).

(2) Although the Hall sensor 13 is disposed in the center of the movable range along the optical axis direction of the lens unit in the first embodiment, the disposed position of the Hall sensor 13 is not limited to the above center position, and may be any position within the movable range of the lens unit along the optical axis direction.

(3) In addition to the aforementioned mobile phone, another electronic apparatuses include a digital still camera, a video camera, a mobile information terminal (PDA: personal digital assistant), a personal computer, a mobile computer or peripheral devices (mouse, scanner, printer or the like) of these apparatus. The digital still camera and the digital video camera are image pickup lens apparatus for, after optically picking up a video image of an object, converting this video image into an electrical signal using a semiconductor device, and saving it as a digital data in a storage medium such as a flash memory.

As described above, a position detecting device detects a position along an optical axis direction of a movably constructed photographing optical system. The position detecting device comprises a magnet integrally movable with the movable lens unit of the photographing optical system with a direction of a line connecting the N-pole and the S-pole thereof oriented substantially parallel to the optical axis direction, a dimension between ends of the respective magnetic poles being larger than a moving distance of the lens along the optical axis direction; a Hall element disposed within a movable range of the lens along the optical axis direction; a detector for detecting a correspondence between outputs of the Hall element and the positions of the lens along the optical axis direction; and a position deriving section for deriving the position of the lens along the optical axis direction based on the output from the Hall element and a detection result by the detector after a detection processing by the detector.

Also, a photographing optical apparatus comprises a photographing optical system including a movable lens movable in an optical axis direction of the photographing optical system, the photographing optical system being adapted for focusing a light image of an object on an image pickup plane, a magnet integrally movable with the lens with a direction of a line connecting the N-pole and the S-pole thereof oriented substantially parallel to the optical axis direction, a dimension between the respective ends of the magnetic poles being larger than a moving distance of the lens along the optical axis direction, a Hall element disposed within a movable range of the lens along the optical axis direction, a detector for detecting a correspondence between outputs of the Hall element and positions of the lens along the optical axis direction, and a position deriving section for deriving a position of the lens along the optical axis direction based on an output from the Hall element and a detection result by the detector after a detection processing by the detector.

The correspondence between the outputs of the Hall sensor and the positions of the lens along the optical axis direction is detected by the detector, and the position of the lens along the optical axis direction is derived by the position deriving section based on the output of the Hall sensor and the detection result by the detector after the detection processing by the detector.

Particularly, since a construction for detecting the position of the lens along the optical axis direction is realized using the magnet and the Hall element, the miniaturization and the cost reduction can be attained as compared to a conventional construction using a light emitting/receiving element and a light blocking plate. Further, since the correspondence between the outputs of the Hall element and the positions of the lens along the optical axis direction is detected and the position of the lens along the optical axis direction is derived based on the detection result, it is not necessary to adjust the positions of the light emitting/receiving element and the light blocking plate at the time of producing a product. Thus, the cost reduction can be realized by eliminating operation steps for such adjustments.

Further, the magnet is integrally movable with the lens with the direction of the line connecting the N-pole and the S-pole oriented substantially parallel to the optical axis direction, the dimension between the ends of the respective magnetic poles is set to be larger than the moving distance of the lens along the optical axis direction, and the Hall element is disposed within the movable range of the lens along the optical axis direction. Thus, the positions of the lens along the optical axis direction and the outputs of the Hall element can be in one-to-one correspondence with each other within the movable range of the lens. As a result, the position of the lens along the optical axis direction can be precisely detected.

Further, an electronic apparatus comprises an image pickup device for photoelectrically converting a received light; a photographing optical system having a movable lens along an optical axis direction and adapted to focus a light image of an object on a light receiving surface of the image pickup device; and the above-mentioned position detecting device for detecting the position of the lens along the optical axis direction. By adopting the position detecting device in the electronic apparatus comprising the image pickup device, the photographing optical system and the position detecting device for detecting the position of the lens along the optical axis direction, the electronic apparatus can be given with the capability of obtaining the effects of the excellent position detecting device.

Preferably, the Hall element may include a constant current circuit for supplying a constant control current to the Hall element, and the constant current circuit includes a circuit element having a specified temperature characteristic and adapted to change the control current in such a manner as to cancel out a change in the output of the Hall element resulting from a temperature change by the temperature characteristic thereof when at least one of the Hall element and the magnet undergoes a temperature change. Thus, even if at least one of the Hall element and the magnet undergoes a temperature change, specified outputs can be stably obtained from the Hall element in relation to the respective positions of the lens along the optical axis direction. As a result, the position of the lens along the optical axis direction can be precisely detected.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds are therefore intended to embraced by the claims.

What is claimed is:

1. A position detecting device for detecting a position of a movable lens provided in a photographing optical system along an optical axis direction of the photographing optical system, comprising:
a magnet integrally movable with the lens with a direction of a line connecting the N-pole and the S-pole thereof oriented substantially parallel to the optical axis direction, a dimension between the respective ends of the magnetic poles being larger than a moving distance of the lens along the optical axis direction;
a Hall element disposed within a movable range of the lens along the optical axis direction;
a detector for detecting a correspondence between outputs of the Hall element and positions of the lens along the optical axis direction; and
a position deriving section for deriving a position of the lens along the optical axis direction based on an output from the Hall element and a detection result by the detector after a detection processing by the detector.

2. A position detecting device according to claim 1, wherein:
the Hall element includes a constant current circuit for supplying a constant control current to the Hall element, and the constant current circuit includes:
a circuit element having a specified temperature characteristic and adapted to change the control current in such a manner as to cancel out a change in the output of the Hall element resulting from a temperature change by the temperature characteristic thereof when at least one of the Hall element and the magnet undergoes a temperature change.

3. An electronic apparatus, comprising:
a photographing optical system including a movable focusing lens movable in an optical axis direction of the photographing optical system;
an image pickup device for receiving a light image of an object passed through the focusing lens of the photographing optical system, and converting the received light into an electrical signal; and
a position detecting device including:
a magnet integrally movable with the focusing lens with a direction of a line connecting the N-pole and the S-pole thereof oriented substantially parallel to the optical axis direction, a dimension between the respective ends of the magnetic poles being larger than a moving distance of the focusing lens along the optical axis direction;
a Hall element disposed within a movable range of the focusing lens along the optical axis direction;
a detector for detecting a correspondence between outputs of the Hall element and positions of the focusing lens along the optical axis direction; and
a position deriving section for deriving a position of the focusing lens along the optical axis direction based on an output from the Hall element and a detection result by the detector after a detection processing by the detector.

4. An electronic apparatus according to claim 3, wherein:
the Hall element includes a constant current circuit for supplying a constant control current to the Hall element, and
the constant current circuit includes:
a circuit element having a specified temperature characteristic and adapted to change the control current in such a manner as to cancel out a change in the output of the Hall element resulting from a temperature change by the temperature characteristic thereof when at least one of the Hall element and the magnet undergoes a temperature change.

5. A photographing optical apparatus, comprising:
a photographing optical system including a movable lens movable in an optical axis direction of the photographing optical system, the photographing optical system being adapted for focusing a light image of an object on an image pickup plane;
a magnet integrally movable with the lens with a direction of a line connecting the N-pole and the S-pole thereof oriented substantially parallel to the optical axis direction, a dimension between the respective ends of the magnetic poles being larger than a moving distance of the lens along the optical axis direction;
a Hall element disposed within a movable range of the lens along the optical axis direction;
a detector for detecting a correspondence between outputs of the Hall element and positions of the lens along the optical axis direction; and
a position deriving section for deriving a position of the lens along the optical axis direction based on an output from the Hall element and a detection result by the detector after a detection processing by the detector.

6. A photographing optical apparatus according to claim 5, wherein:
the Hall element includes a constant current circuit for supplying a constant control current to the Hall element, and
the constant current circuit includes: a circuit element having a specified temperature characteristic and adapted to change the control current in such a manner as to cancel out a change in the output of the Hall element resulting from a temperature change by the temperature characteristic thereof when at least one of the Hall element and the magnet undergoes a temperature change.
